(19) United States
(12) Patent Application Publication
(10) Pub. No.: US 2013/0315568 A1
(43) Pub. Date: Nov. 28, 2013

(54) SYSTEM AND METHOD FOR THE CREATION OF AN E-ENHANCED MULTI-DIMENSIONAL PICTOFILM PRESENTATION USING PICTOOVERLAY INTERFACE ENHANCED TRANS-SNIP TECHNOLOGY

(71) Applicant: Ian A. R. Boyd, North Las Vegas, NV (US)

(72) Inventor: Ian A. R. Boyd, North Las Vegas, NV (US)

(21) Appl. No.: 13/902,957

(22) Filed: May 27, 2013

Related U.S. Application Data
(60) Provisional application No. 61/652,306, filed on May 28, 2012.
(60) Provisional application No. 61/705,686, filed on Sep. 26, 2012.
(60) Provisional application No. 61/716,508, filed on Oct. 20, 2012.
(60) Provisional application No. 61/750,022, filed on Jan. 8, 2013.
(60) Provisional application No. 61/763,749, filed on Feb. 12, 2013.

(51) Int. Cl. G11B 27/031

(52) U.S. Cl. CPC G11B 27/031
USPC 386/282

(57) ABSTRACT

A software application program on a computer platform transforms a structured basic concept into a pictorial interpretation in the form of an E-Enhanced Multi-Dimensional PictoFilm Presentation using PictoOverlay Interface Enhanced Technology that structures from the basic concept elements required as critical content for the location, event, actions, outcomes and characters to transform the basic concept is transformed into a series of moving pictures with special effects and enhancements, both audio and visual, that end up making the basic concept come alive visually, emotively and evocatively. More specifically, the software application program combines and layers static images and displays them dynamically and sequentially, adding audio and video enhancements to create a presentation like a film. The software program further transforms the basic concept into an infinitely variable array of pictorial elements and enhancements that extend the basic concept to intrigue, entertain and inform.

### CROSS REFERENCE TO RELATED APPLICATIONS

This application claims the benefit of U.S. Provisional Application No. 61/652,306 filed May 28, 2012 entitled AUDIO VIDEO FILM CREATOR FROM STORYLINE, CAST AND CONTEXT SETTINGS INPUT, U.S. Provisional Application No. 61/705,686 filed Sep. 26, 2012 entitled SYSTEM AND METHOD FOR THE CREATION OF ENHANCED AUDIO VISUAL STORYBOARDS USING A LAYERED COMPOSITE IMAGE GENERATOR, U.S. Provisional Application No. 61/716,508 filed Oct. 20, 2012 entitled SYSTEM AND METHOD FOR THE CREATION OF AN ENHANCED MULTI-DIMENSIONAL PICTOGAME, U.S. Provisional Application No. 61/750,022 filed Jan. 8, 2013 entitled SYSTEM AND METHOD FOR THE CREATION OF AN E-ENHANCED MULTI-DIMENSIONAL PICTOKIDS PRESENTATION and U.S. Provisional Application No. 61/763,749 filed Feb. 12, 2013 PAYMENT AND ACCOUNT MANAGEMENT SYSTEM USING PICTOOVERLAY TECHNOLOGY which are hereby incorporated herein by reference in their entireties.

### FIELD OF INVENTION

The present invention relates to a software application system and method for creating an enhanced featured, displayable, narrated, musicked, Multi-Dimensional PictoFilm Presentation using PictoOverlay Interface Enhanced Trans-Snip Technology (P.O.I.N.T.) to dynamically present an artistic, informative, educational, factual, plot and storyline, or other Basic Concept in an evocative and emotive format. The POINT Technology Software Application relates generally to a video or film storyboard creator from critical contents and more specifically it relates to an audio video film creator from storyline, cast and context settings input for the creation of a Simulated Audio Video Pilot Preview of a completed version of an original work from three Basic Inputs: Critical Component Content (Structured Storyline, Act by Act, Scene by Scene); Cast of Character PROFILES; and Event and Action SETTINGS. Proprietary software concepts define the Key Basic Input Elements that allow for an effective final audio video Multi-Dimensional rendition of the original work that is simply altered for alternative preferred versions.

### BACKGROUND OF THE INVENTION

The most sophisticated complete way to tell a story or describe an idea or concept is to fully render it in the form for which it was intended, for example as a film, a play, a musical or other theatrical presentation. The development and execution of this creative process in writing, performing, filming, editing and presenting may involve numerous hours, many people, and a significant cost. A barrier to this type of development often is the initial funding to incorporate the resources necessary to form and advance this process. While basic methods to describe a concept exist, they vary from a story, to a treatment, a slideshow, a demonstration, or a presentation with each a more sophisticated media for communicating a Concept. Digital means to present the idea, plot, storyline or overview of a production are for example, MS PowerPoint or other presentation software, Adobe Photo Shop or other image editing software, and/or audio recorders-mixers for sound reproduction, or video recording and film editing software. Not available however is software that expands the idea, concept, plot or storyline into a presentable multi-functional, Multi-Dimensional film-like narrated, musicked format (with all its components pictorially page-presented sequentially in a page-driven Blueprint) and into a structured form that has significantly more content than its original basic idea with instantly changeable variable components all without a significant financial investment. Importantly, to achieve any of these in any detail requires more or less specific input from the creator where the result is invariably one-off, final and finite.

### SUMMARY OF THE INVENTION

The invention generally relates to a PictoFilm Storyboard Creator from critical content which includes CREATE; SETTINGS; PROFILES; WEBLISATION & THE ARCHITECTURAL BLUEPRINT; REALIZATION-RENDERING-REMAKE; SLIDE-GENERATION-SEQUENCING; SONG & THEME MUSIC GENERATION; NARRATION; MEDIA MODIFICATION; and NAVIGATE-DISPLAY-PRINT.

The PictoFilm Application Software system and method may be implemented using the STAR-RAID-POINT Development Software Application for producing, delivering and displaying universally adaptable, scalable content and code that is compatibly displayable in “CORE Application” and “Resident Server” form, on all mobile devices irrespective of specifications and by all other computer processing display devices that have in common the ability to use a web-net browser and/or other application software such as an HTML viewer to display a web based page on HTML, CSS, JavaScript, or any of their versions. Specifically, the software methodology applies scalable small file format that is rapidly downloaded to a digital device, with the intent of creating-emulating a resident server for ease and speed of access, where such code and content could and would include a dedicated Web browser, a common adaptable Graphical User Navigation Launch Interface, Small File formats applicable to mobile devices, STAR-RAID-POINT (SRP) technologies, and exchangeable adaptable Content Based Modules. The system is based on a replaceable-modifiable resident server where content/code can be added to, replaced, expanded, contracted to change, and altered to modify the information and/or content to be displayed. This system methodology produces application code and content that is not dependent on Internet/Web access to display unspecified amounts of an applications functionality, the application being either web based or other application code and content.

This system is designed not only to cater to Web Based HTML code but is intended to apply to modification of resident native application code and content where the modular code/content concept and characteristics are also applied, and where linkage to HTML code is desirable or effective as separate resident packages. In native code applications, resident code would be modularized to allow additional or replaceable packets of content code to be delivered to modify/change the existing application functionality, code and content.

The “software development and executable application” system uses adaptable and adapting code that provides scalable compatibility and functional adaptability across multiple digital devices such as any computer, cellular phone, iPhone, smart phone, iPad, tablet computer or other digital device. The application uses Scalable Transparent Adaptable Resident-Recordable Addable Interface Design (S.T.A.R.-R.A.I.D.) and PictoOverlay Interface Enhanced Trans-Snip (P.O.I.N.T.) Technology to dynamically present and provide for the creation of and access to numerous personal and commercial applications, including but not limited to adventure stories, games, puzzles, films, shopping and other interactive applications that are displayable at any resolution and in any format of any digital screen without utilizing software code that is specific to a particular device or format, meaning that the same code and content is utilized to interface with and display the STAR-RAID-POINT Application on any digital device. The STAR-RAID-POINT Application further uses Variable Graphics Code that is associated with each Trans-Snip which provides, unlike hard coding of an application, unlimited flexibility in modifying any variable within the application without changing the “Core Code” of the application. Using this embedded code associates attributes with each Trans-Snip that allows the PictoFilm Application Software to change, replace, add, and extend the characteristics of any Trans-Snip through priority or otherwise and also add, replace, update, change, add to, or extend the Trans-Snip through any other core code or resident code and content associated with that Trans-Snip. The fact that that a Trans-Snip is a variable provides additional power and flexibility to alter current core or resident code and functionality, by changing every aspect completely by replacing code associated with the Trans-Snip. Embedding code to the Trans-Snip provides powerful overlay capability with the embedded code hidden within the pictorial element of the Trans-Snip which is in a different format mainly Portable Network Graphics format (PNG) or the Graphics Interchange Format GIF. This structure of Trans-Snip variables has additional capability of priority, variability and functionality applicable in general but particularly specific to Mobile Core Code/Content and Resident Server Code/Content.

In order to replace PictoFilm content, the POINT Technology provides an Encrypted Coordinate File Format structure that identifies variables through coordinate positions within a structured layout within an Architectural Blueprint. Related components that make up a Trans-Snip, Composite Image, PictoStory or other component may be grouped within the Architectural Blueprint. To copy or replace a variable, an alternative variable that includes the desired content is selected and automatically renamed by the software application to the appropriate coordinate file name within the Architectural Blueprint which immediately replaces the content within the display of the application. Each variable and feature within a Data Store Resource is developed using the PictoOverlay Technology and a variable may be a Trans-Snip, a Trans-Snip with an Enhancement, an Enhancement, Raster formatted text or layered Trans-Snips that form Composite Images or PictoStorys within the PictoFilm Application. The new content variable may further provide a change in priority of a Trans-Snip or an Enhancement so that the new content variable is immediately displayed; or the new content is displayed and then fades; or changes in color; or audio associated with the variable plays a song or narration about the content. Priority as an attribute of a variable Trans-Snip defines the accessibility and timing of an enhancement of the content variable within the display, the Variable Graphics Code for the Enhancement is therefore adaptable to any device to display sound, visual content, animation or other sound and visual effects within the characteristics and specifications of the device.

The PictoFilm Content Trans-Snip may be prioritized within the Architectural Blueprint meaning structurally layered on top of other Trans-Snips to be accessible to activate within a prior to other enhanced Trans-Snips thereby creating timing and sequencing for narration, theme or background music, display within the PictoFilm, animation or other sound or visual effects within the PictoFilm Multi-Dimensional Presentation.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object of the invention is to provide an Audio Video PictoFilm Creator From Storyline, cast and context settings input for the creation of a Simulated Audio Video Pilot PictoFilm Preview of a completed version of an original work from 3 Basic Inputs: Critical Component Content (Structured Storyline, Act by Act, Scene by Scene); Cast of Character PROFILES; and Event and Action SETTINGS. Proprietary software concepts define the Key Basic Input Elements that allow for an effective final audio video rendition of the original work that is simply altered for alternative preferred versions.

Another object of the invention is to provide an Audio Video PictoFilm Creator From Storyline, Cast And Context Settings Input that generates a “Simulated Audio Video Pilot PictoFilm Preview” of the story-Concept-concept, by using the PictoFilm CREATE process: Structuring and sequencing scene by scene components of the storyline in the form of ‘Audio Video Narrated Musicked StoryBoards’, which as a whole, render a simulated ‘Preview PictoFilm’ of the original Concept-concept storyline. The CREATE process involves scene-by-scene required ‘Critical Content Component Inputs’, using the method known as 6WCOOL, Who? What? Where? When? Why? HoW? and How COOL. The last COOL relates to inputting content that delivers Dramatic Effect.

Another object is to provide an Audio Video PictoFilm Creator From Storyline, Cast And Context Settings Input that generates a “Simulated Audio Video Pilot PictoFilm Preview” of the story-Concept-concept by using the PictoFilm SETTINGS process that consists of the SETTINGS input component that requires Input Settings and pictorial selection from provided Montage Pages that require scene by scene inputs that ‘SHOW not TELL’ the storyline. The input categories are Geographic Location, Era-Time-Season-Weather, Event and Context, Action & Outcome. These settings allow pictorial selection from Image Selection Montage Pages that meet the criteria of Show-not-Tell and are available for variations by the user-creator-technician to provide alternate multiple versions of the Audio Video Narrated Musicked Multi-Dimensional PictoFilm Presentation. The Image Selection Montage Pages are supported by internet linkage to the STAR-RAID-POINT Remote Server to offer unlimited options and choices for Variable Content for the PictoFilm. The Content is developed using PictoOverlay Technology in a Portable Network Graphics (PNG) format with embedded code providing enhancements to dynamically present text, music, narration, sound effects, video, visual effects, animation, or any other supportive element.

Another object of the invention is using PictoOverlay Technology in associating an Enhancement with a Trans-Snip, Composite Image, PictoStory or other feature or variable of the application to add text, music, narration, sound effects, video, visual effects, animation, or any other supportive element to dynamically present a Trans-Snip or other component within the PictoFilm Presentation.

Another object of the invention is the prioritization of an Enhancement to dictate the timing of the activation of the Enhancement within the content of the application Multi-Dimensional PictoFilm Presentation.

Another object is to provide an Audio Video PictoFilm Creator From Storyline, Cast And Context Settings Input that generates a “Simulated Audio Video Pilot PictoFilm Preview” of the story-Concept-concept using the PictoFilm Cast & Character PROFILES process that comprises a character PROFILE input component which requires casting the characters in the storyline from an unlimited Data Store Resource of images of actors-actresses, animals, etc. and inputting complete socio-economic, academic, cultural, ethnical, ethical, religious profile information for each cast character member resulting in a PictoFilm Character Profile on that character that is used pictorially in the project and available for recasting or change. Using a Choice Generator, information about a character within the Data Store Resource is continually updated to provide an always current profile.

Another object is to provide an Audio Video PictoFilm Creator from Storyline, Cast and Context Settings Input that generates a “Simulated Audio Video Pilot PictoFilm Preview” of the story-Concept-concept using the PictoFilm WEBLIZATION & ARCHITECTURAL BLUEPRINT ACTIVATION process that involves the creation of scene by scene PictoFilm StoryBoard (Audio Video Narrated Musicked Storyboards) derived from the inputs categorized above. This two-step process ‘Activates’ the static input PictoFilm StoryBoard into providing one click rendering of audio, video, slideshows, narration, music, etc. and then, as a second step creates a Web (or hard drive) version of that Interim PictoFilm StoryBoard stage which is then viewable, modifiable, alterable and forms the basis of what will be seen in a final Multi-Dimensional PictoFilm Presentation version selection and the process of compilation and sequencing set out below. This WebliZation is also used in the final presentation output and allows access to overviews of the entire work, any act, any scene, any character, etc. while also offering a full length Multi-Dimensional PictoFilm Presentation rendering of the creative work.

Another object is to provide an Audio Video PictoFilm Creator from Storyline, Cast and Context Settings Input that generates a “Simulated Audio Video Pilot PictoFilm Preview” of the story-Concept-concept using the PictoFilm REALIZATION, RENDERING & REMAKE process. This PictoFilm Application allows user modification of input elements and PICTOFILM STORYBOARD alterations and/or sequencing-compilation selections that renders a completely alternate version of the work, in as many variations as is desired by the user such as a change of actor, location, setting, weather, song, background music, and other features of the Multi-Dimensional PictoFilm Presentation.

Another object is to provide an Audio Video PictoFilm Creator from Storyline, Cast and Context Settings Input that generates a ‘Simulated Audio Video Pilot PictoFilm Preview” of the story-Concept-concept using the PictoFilm SLIDE GENERATION (Complex) & SLIDE SEQUENCING Production Control Tools module. This generates a “Simulated Audio Video Pilot Preview” of the story-Concept-concept using the PictoFilm SLIDE GENERATOR (Complex) and SLIDE SEQUENCER process Generator and Compiler.

Another object is to provide an Audio Video PictoFilm Creator From Storyline, Cast And Context Settings Input that generates a “Simulated Audio Video Pilot PictoFilm Preview” of the story-Concept-concept using the PictoFilm SONG & THEME MUSIC process using the Song Theme Generator that through Enhancements adds audio to the process in conjunction with narration and sound effects below.

Another object is to provide an Audio Video PictoFilm Creator From Storyline, Cast And Context Settings Input that generates a “Simulated Audio Video Pilot PictoFilm Preview” of the story-Concept-concept using the PictoFilm NARRATION process based on Critical Component and Context Settings input and merge matched using prioritization of Enhancements of components within the PictoFilm StoryBoard to create audio for full motion video simulation including action dramatic narration and sound effects.

Another object is to provide an Audio Video PictoFilm Creator From Storyline, Cast And Context Settings Input that generates a “Simulated Audio Video Pilot PictoFilm Preview” of the story-Concept-concept using the PictoFilm MEDIA MODIFICATION process that consists of using the Blueprint Generator and Enhancements that modify the Architectural Blueprint layout and Input formats to better suit differing media output preferences for example for a Book, Play, Musical, Ballet, Music Video, Film, Game, Game Show, TV Show, Reality Show, Web Presentation, Political-Debate Speech or other media formats.

Another object is to provide an Audio Video PictoFilm Creator From Storyline, Cast And Context Settings Input that generates a “Simulated Audio Video Pilot PictoFilm Preview” of the story-Concept-concept using the PictoFilm NAVIGATE DISPLAY & PRINT process that consists of the Reference Page Map structure of the Architectural Blueprint and the PictoFilm StoryBoard hard copy output of Input Criterion, Search results and all screen visualizations of final product and interim build up.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram illustrating the Modules A, B, and C that in a first embodiment make up the E-Enhanced Multi-Dimensional PictoFilm Application Software of the present invention;

FIG. 2 is a block diagram of a first embodiment of the computer platform of the E-Enhanced Multi-Dimensional PictoFilm Application Software of the present invention;

FIG. 3 is a flow chart of the process steps for the development of a variable content E-Enhanced Multi-Dimensional PictoFilm Presentation;

FIG. 4A is a diagrammatic representation of a first embodiment of a PictoFilm Textual Plot Line developed using the PictoFilm Generator in an embodiment of the E-Enhanced Multi-Dimensional PictoFilm Application Software of the present invention;

FIG. 4B is a diagrammatic representation of a first embodiment of a PictoFilm Play Sheet developed using the PictoFilm Generator in an embodiment of the E-Enhanced Multi-Dimensional PictoFilm Application Software of the present invention;

FIG. 4C is a diagrammatic representation of a first embodiment of a PictoFilm Cast of Characters developed using the PictoFilm Generator in an embodiment of the E-Enhanced Multi-Dimensional PictoFilm Application Software of the present invention;

FIG. 5 is a diagrammatic representation of a first embodiment of a Referenced Page Map of the PictoFilm Blueprint in an embodiment of the E-Enhanced Multi-Dimensional PictoFilm Application Software of the present invention;

FIG. 6 is a diagrammatic representation of a first embodiment of a Settings—Location Montage Page in an embodiment of the E-Enhanced Multi-Dimensional PictoFilm Application Software of the present invention;

FIG. 7 is a diagrammatic representation of a first embodiment of a PictoStory Blueprint showing the Settings—Location for a Scene or Part Scene from a PictoFilm in an embodiment of the E-Enhanced Multi-Dimensional PictoFilm Application Software of the present invention;

FIG. 8 is a diagrammatic representation of a first embodiment of a PictoStory Blueprint showing the Musical Accompaniment for a Scene or Part Scene from a PictoFilm in an embodiment of the E-Enhanced Multi-Dimensional PictoFilm Application Software of the present invention;

FIG. 9 is a diagrammatic representation of a first embodiment of a Character Profile in an embodiment of the E-Enhanced Multi-Dimensional PictoFilm Application Software of the present invention;

FIG. 10 is a diagrammatic representation of a first embodiment of an image library from a Character Profile in an embodiment of the E-Enhanced Multi-Dimensional PictoFilm Application Software of the present invention;

FIG. 11 is a diagrammatic representation of a first embodiment of a Character Montage Page in an embodiment of the E-Enhanced Multi-Dimensional PictoFilm Application Software of the present invention;

FIG. 12 is a diagrammatic representation of a first embodiment of a Cast of Characters listing in a PictoFilm Blueprint in an embodiment of the E-Enhanced Multi-Dimensional PictoFilm Application Software of the present invention;

FIG. 13 is a diagrammatic representation of an embodiment of a Scene within PictoFilm Blueprint in an embodiment of the E-Enhanced Multi-Dimensional PictoFilm Application Software of the present invention;

FIG. 14 is a diagrammatic representation of an embodiment of Pages within a PictoFilm Blueprint in an embodiment of the E-Enhanced Multi-Dimensional PictoFilm Application Software of the present invention; and

FIG. 15 is a diagrammatic representation of the access levels to a Multi-Dimensional PictoFilm Presentation in an embodiment of the E-Enhanced Multi-Dimensional PictoFilm Application Software of the present invention.

### DETAILED DESCRIPTION OF THE INVENTION

Turning now descriptively to the drawings, in which similar reference characters denote similar elements throughout the several views, the figures illustrate the E-Enhanced Multi-Dimensional PictoFilm Application Software transforms a structured plot, storyline, or idea referred to herein as a Basic Concept which may be for example, an engineering concept, educational instruction, an historic event, a musical piece, a short story, or an in depth and detailed full-length feature film script into an infinitely variable E-Enhanced Multi-Dimensional PictoFilm Presentation.

### Details of the E-Enhanced Multi-Dimensional PictoFilm Software Modules

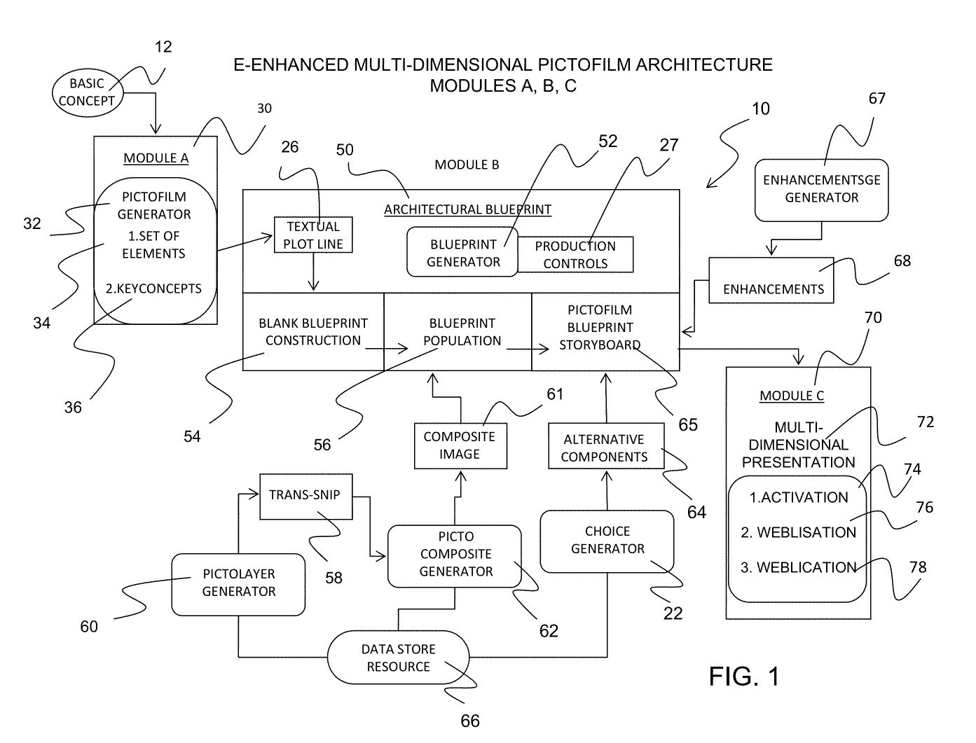

In a first embodiment as shown in FIG. 1, the E-Enhanced Multi-Dimensional PictoFilm Application Software system indicated diagrammatically as 10, comprises three modules that include a PictoFilm Generator 32 in Module A, a Blueprint Generator 52 in Module B, and PictoFilm Presenters in Module C, Within these modules, software application tools on a computer platform 5 transform a Basic Concept 12 to a Textual Plot Line 26 using a PictoFilm Generator 32 that structures the Basic Concept 12 into a Set, Series or Sequence of Elements 34 and applies a KeyConcepts Multiple Query 36 to these Elements 34. The Sequence of Elements 34 is used to structurally layout a blank transparent Architectural Blueprint 54 and a File Folder Structure for the required modifications of input, output, structure, display, components, and other features to suit the following types of media that the project is serving. The structural layout developed by the PictoFilm Generator provides for the development of a Sequence of Elements 34 and Textual Outlines 26 in numerous media formats such as to develop books, plays, musicals, music videos, ballets, films, documentaries, games, game shows, TV Shows, Reality Shows, and Web Presentations. The inputs for these are in a slightly modified format to suit the particular medium and represent the project or work more accurately within the structure of the Architectural Blueprint.

The Architectural Blueprint 56 is populated with the set of Textual Plot Lines 26 providing an expanded textual description of the Basic Concept 12. A pictorial representation of this textual description is created by developing a set of Trans-Snips 58 using a PictoLayer Generator 60. Using a PictoComposite Generator 62, the Trans-Snips 58 are layered to create a set of Composite Images 61. The Architectural Blueprint 56 is populated with these Composite Images 61 and Trans-Snips 58 forming PictoStorys to be used as Scenes and Part Scenes in the Multi-Dimensional PictoFilm Presentation 72. The Trans-Snip 58, Composite Images 61 and other components of the PictoStorys are enhanced to Animate, add Audio, add Narration, add Sound and Video Effects, and other features to transform the PictoFilm into a dynamic, Enhanced Multi-Dimensional PictoFilm Presentation using the Production Controls 27. In Module C, the E-Enhanced Multi-Dimensional PictoFilm Presentation may be rendered partially or in its entirety using three access formats, Activation 74, WebliZation 76 and WebliCation 78. Using the Choice Generator 22, Alternative Components 64 related to the Basic Concept 12 are identified and stored within the Data Store Resource 66 to allow for the replacement of any Component to transform the Basic Concept 12 into infinitely variable characters, settings and outcomes creating multiple versions of the E-Enhanced Multi-Dimensional PictoFilm Presentation.

### Application Software Computer Platform

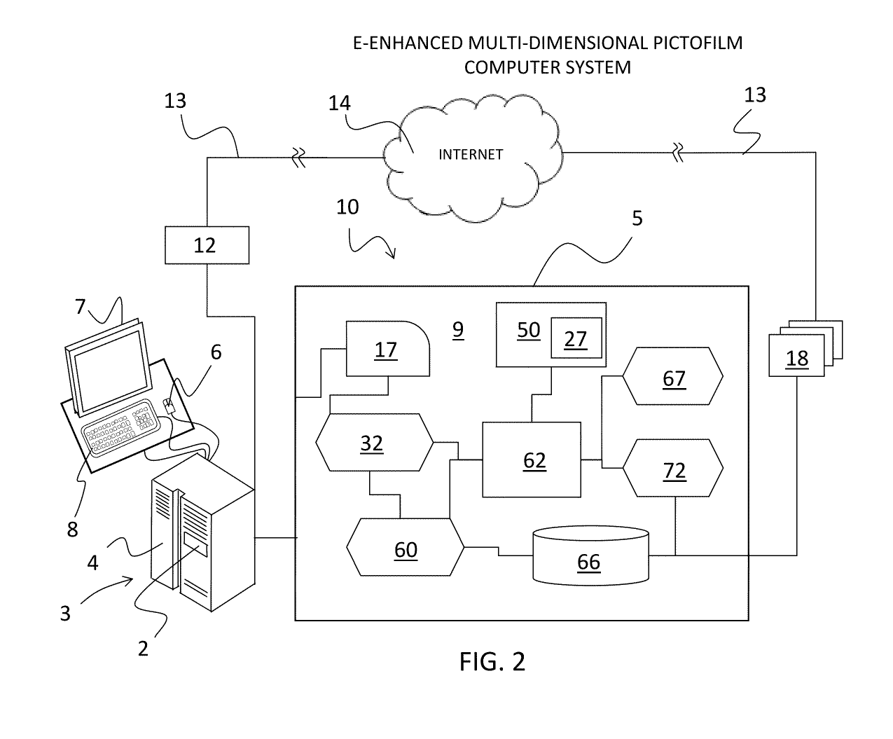

As shown in FIG. 2, in a first embodiment the E-Enhanced Multi-Dimensional PictoFilm Application Software may be implemented in computer hardware and computerized equipment. For example, the method can be performed using a system including one or more digital communications devices and/or one or more personal computers and data servers. Although the computer system 3 is shown for the purpose of illustrating a preferred embodiment, the present invention is not limited to the computer system 3 shown, but may be used with any electronic data processing system such as found in personal or other digital communications devices, cellular phones and other mobile devices, home computers, tablet computers, or any other system for the processing of digital data. The computer system 3 includes a server computer 4 having a microprocessor-based unit 5 (also referred to herein as a processor) for receiving and processing software programs and for performing other processing functions. An output device 7 such as a visual display is electrically connected to the processor unit 5 for displaying user-related information associated with the software, e.g., by means of a graphical user interface. A keyboard 8 may also be connected to the processor unit 5 for permitting a user to input information to a software program. As an alternative to using the keyboard 8 for input, a mouse 6 may be used for moving a selector on the display 7 and graphical user interface, or alternatively a touch screen input device may be provided for selecting an item and providing input to the processor 5. It is to be appreciated that the input is not limited to the known input apparatus and methods but includes input methods and devices which may yet be developed.

Memory and data storage, in any form, can be included and is illustrated as a hard-disk device such as computer readable storage medium 2, which can include software programs, and is connected to the microprocessor based unit 5 for providing a means of inputting the software programs and other information to the microprocessor based unit 5. Multiple types of memory can also be provided and data can be written to any suitable type of memory. Memory can be external and accessible using a wired or wireless connection, either directly or via a local or large area network, such as the Internet. Still further, the processor unit 5 may be programmed, as is well known in the art, for storing the software program internally. A printer or other output device can also be connected to the processor unit 5 for printing a hardcopy of the display from the computer system. The processor unit 5 can have a network connection 13, such as a telephone line, network cable or wireless link, to an external network, such as a local area network or the Internet 14.

The output device 7 provides visually to the user transactional, interactive or variable data that has been Subject to transformations. The output device 7 can be a monitor or other visual computer screen or graphical user interface (GUI), a printer or other output device that provides a visual or other representation of a final output from the processor unit 5. The output device 7 can also be an output device that provides the transactional data as a digital file. The processor unit 5 provides means for processing the transactional, interactive or variable data to produce readily discernible, informational and organized images and data on the intended output device or media. The present invention can be used with a variety of output devices that can include, but are not limited to, a digital photographic printer and soft copy display. Those skilled in the art will recognize that the present invention is not limited to just these mentioned data processing functions.

The server computer 4 can store a computer program product having a program stored in the computer readable storage medium 2, which may include, for example: magnetic storage media such as a magnetic disk or magnetic tape; optical storage media such as an optical disc, optical tape, or machine readable bar code; solid state electronic storage devices such as random access memory (RAM), read only memory (ROM) or flash memory data storage devices. The associated computer program and data server may be implemented through application software 17 on a SaaS (Software as a Service) or on demand computing service such as a Cloud or shared resource database through a web browser. A secure login with password may be provided to remotely access the software 17 through an intranet or internet connection. One or more of the devices to access the application software may be connected wirelessly, such as by a cellular link, either directly or via a network. It is to be appreciated that such devices can be mobile devices (e.g., camera, PDA, iPod, iPad, tablet computer or cell phone that can be used as a processing unit, a display unit, or a unit to give processing instructions), and as a service offered via the World Wide Web.

In each context, the invention may stand alone or may be a component of a larger system solution. Furthermore, human interfaces, e.g., the input, the digital processing, the display to a user (if needed), the input of user requests or processing instructions (if needed), the output, can each be on the same or different devices and physical locations, and communication between the devices and locations can be via public or private network connections, or media based communication. Where consistent with the foregoing disclosure of the present invention, the method of the invention can be fully automatic, may have user input (be fully or partially manual), may have user or operator review to accept/reject a result, or may be assisted by data or metadata (data or metadata that may be user supplied, supplied by another computer program or database from a different application or determined by an algorithm). Moreover, the algorithm(s) may interface with a variety of workflow user interface schemes.

In the following description, some features are described as “software” or “software programs”. Those skilled in the art will recognize that the equivalent of such software can also be readily constructed in hardware. Because data manipulation algorithms and systems are well known, the present description emphasizes algorithms and features forming part of, or cooperating more directly with the method and hardware of the presently disclosed invention. General features of databases, digital communications devices, email and computerized systems are likewise well known, and the present description is generally limited to those aspects directly related to the method and related hardware of the invention. Implementation of the present invention may be in conjunction with one or more database management systems (DBMS) such as Oracle, IBM DB2, Microsoft SQL Server, PostageSQL, MySQL, or others using widely supported database languages such as SQL to define and manipulate data and perform data queries. Other aspects of such algorithms and apparatus, and hardware and/or software for producing and otherwise processing the data involved therewith, not specifically shown or described herein may be selected from any such systems, algorithms, Components, and Elements known in the art. The present invention may further be implemented on a secure web server 9 using SSL, SHTTP or other security protocols for encryption and decryption of transmitted data. Data replication and redundancy is performed automatically and all servers are secured in optimal conditions. Further security is provided where each story project is setup using a unique domain name that is accessible only using login identifications and passwords. User logins and preferences link specific user information to their user identification to provide predetermined access to information for each user. Administrative tools within the application software 17 monitor, add or remove users, manage content and set restrictive/predetermined access parameters to users of the system. The access parameters within Module C 70 as described in further detail herein may be in one of three formats of Activation 74, WebliZation 76, or WebliCation 76 This controlled access may further provide data files 18 from the Internet 14 or an intranet to be categorized and stored within the Data Store Resource 66.

### PictoFilm Software Application Create—Scene by Scene, Act by Act Structure Based on PictoFilm StoryBoard Dependent on 6WCOOL Predefined Required Critical Component Content Criteria

Using the Blueprint Generator 52, the E-Enhanced Multi-Dimensional PictoFilm Application Software 10 structures a blank Architectural Blueprint 54 into five (5) Acts and five (5) Scenes (or any adequate number for the Basic Concept 12), each scene with five (5) component parts. Each Scene and its five component parts are extended by applying the 6WCOOL input convention to result in critical component content. The 6WCOOL inputs are defined by specific version(s) of Who?, What?, Where?, When?, Why?, HoW?, and How COOL?, the latter being shorthand for specifying ‘Dramatic Effect Intended’. The storyline is subdivided and structured according to stringent dramatic rules (6WCOOL) to assure a comprehensive and effective ultimate simulated rendition of the intended work. The Architectural Blueprint 50 and Data Store Resource 48 provides structural and functional variations that are dependent on changes of the basic input and responder input on the context and concept of the PictoFilm storyline.

### Process Steps to Create a Multi-Dimensional PictoFilm Presentation

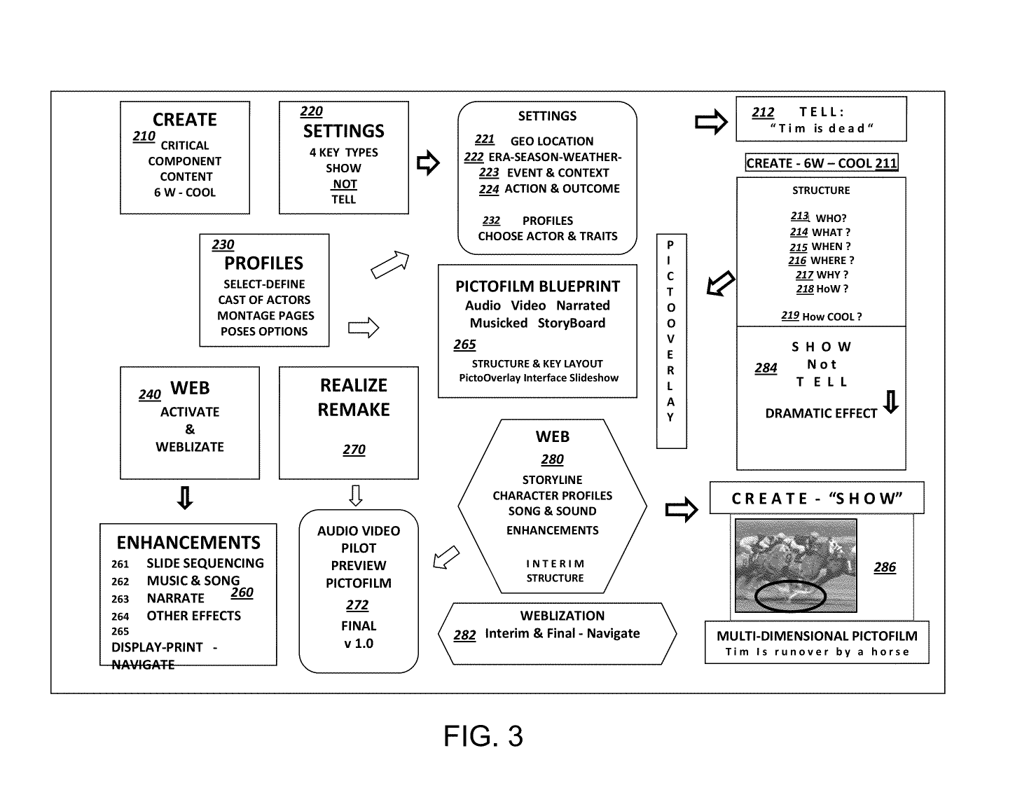

The process to create a Multi-Dimensional PictoFilm Presentation is shown in FIG. 3, with the structure and components that will be formatted within the Architectural Blueprint 50 for the Scenes and Part Scenes. The process steps include PictoFilm Create 210 the Scene By Scene, Act By Act Structure within the PictoFilm Blueprint StoryBoard 265 based on the Basic Concept 212, dependent on 6WCOOL Predefined Required Critical Component Content Criteria 211, the Who?—Principal Characters in Scene 213, the What?—Subject Matter—Event & Context, Action Outcome 214, the When?—Era, Time of Day, Weather Season 215, the Where?Geographic Location And Location Specifics And Setting 216, the Why? Event Action Is Part of Story Plot 217, the How?—Is The Action-event Best Pictorially Layered 218, and the How-cool? Idea That Produces High Dramatic Effect 219. The PictoFilm Settings 220 including the Geographic Location Selection 221 (Scene By Scene), the Era-time-season-weather Selection (Scene By Scene) 222, the Event And Context (Scene By Scene) 223, the Actions and Outcome (Scene By Scene) 224 with each description of the Settings. A series of Image Selection Montage Pages are presented with images for each Settings selection with an internet connection for an unlimited number of choices. The selected settings are transformed to Trans-Snips 58 and Composite Images 61 to be used in PictoStorys for the Scenes and Part Scenese of the Multi-Dimensional PictoFilm Presentation.

A next process step for the selection of 6WCOOL Predefined Required Critical Component Content Criteria 211 is PictoFilm Character Profiles 230 to select the Cast that will represent the Character within the PictoFilm. Character Descriptions for each character are taken from the Textual Plot Lines 26 and are used to create Character Preferred Profile Inputs such as Age, Looks, and other Key Info. The image selections from the Montage Pages for Settings 220 and Characters are transformed into Small File Format Embedded Code Trans-Snips 58 and Composite Images 61 that are located within the PictoFilm Blueprint StoryBoard 65 at formatted locations for these critical input content. The Trans-Snips 58 and Composite Images 61 are used to create PictoStorys that are also located within the Architectural Blueprint 50 providing a PictoFilm Weblization & Wall 240 that provides for review, access and modification of all of the PictoFilm Components and Content. The Wall's Page Driven Format And Page, Cell and Resolution based coordinate layout provides for navigation to any component using a Referenced Page Map without scrolling or zooming. Selecting any component within the Page Map displays each component page, such as a Composite Image Page that displays all of the Trans-Snips that form the Composite Image 61. Each Scene and Part Scene is structured as Pages within the Architectural Blueprint 50 with all components of the Scene and Part Scenes accessible within a Page. Every component has a unique encrypted file name that translates to a specific location within the Architectural Blueprint 50 layout. Each component as well may be associated with one or more Embedded Code Enhancements 260 to dynamically present and Animate 261, add Audio 262, add Narration 263, add Sound and Visual Effects 264, Display, Print, or Navigate 265 to the component.

An Enhanced component such as a Trans-Snip 58, Composite Image 61 or PictoStory may then be Web Actviated and Weblizated 240 to view in a Slide Show, and activate the Enhancements 260 associated with the Components. The Activation and WebliZation features provide for Recording, Dictating, Filling In, Composing Music, adding Narrative and adding these Enhancements 260 Scene By Scene, Part Scene by Part Scene to the Multi-Dimensional PictoFilm Presentation. Enhancements 260 provide access to Actions, Hyperlinks, Macros, and conversions to HTML and Dynamic HTML (D-HTML) for presentation of any Component. In a review of the PictoFilm 272, at the PictoFilm Realize, Render, Remake Software Process Step 270, any Critical Content Component Variable may be changed to an Alternative Component to produce an Alternate Interim Output Presentation 280 as well as possible multiple versions of a Final Preview Output (i.e. Directors Cut) in order to Show Not Tell 284 the Basic Concept 212. Any character, setting, event or outcome may be changed to produce a completely different Multi-Dimensional PictoFilm Presentation. Scenes may be changed, Songs, Music, Narrative may be changed, a Scene may be Sped Up or Lengthened, or be replaced with a new Scene or Act, or be removed. With Multiple Versions of the PictoFilm available within the Architectural Blueprint 50 any version may be selected and realized for viewing or modification with each interpretation 286 available to present, print, or make accessible through a web hyperlink a portion or the entire Presentation.

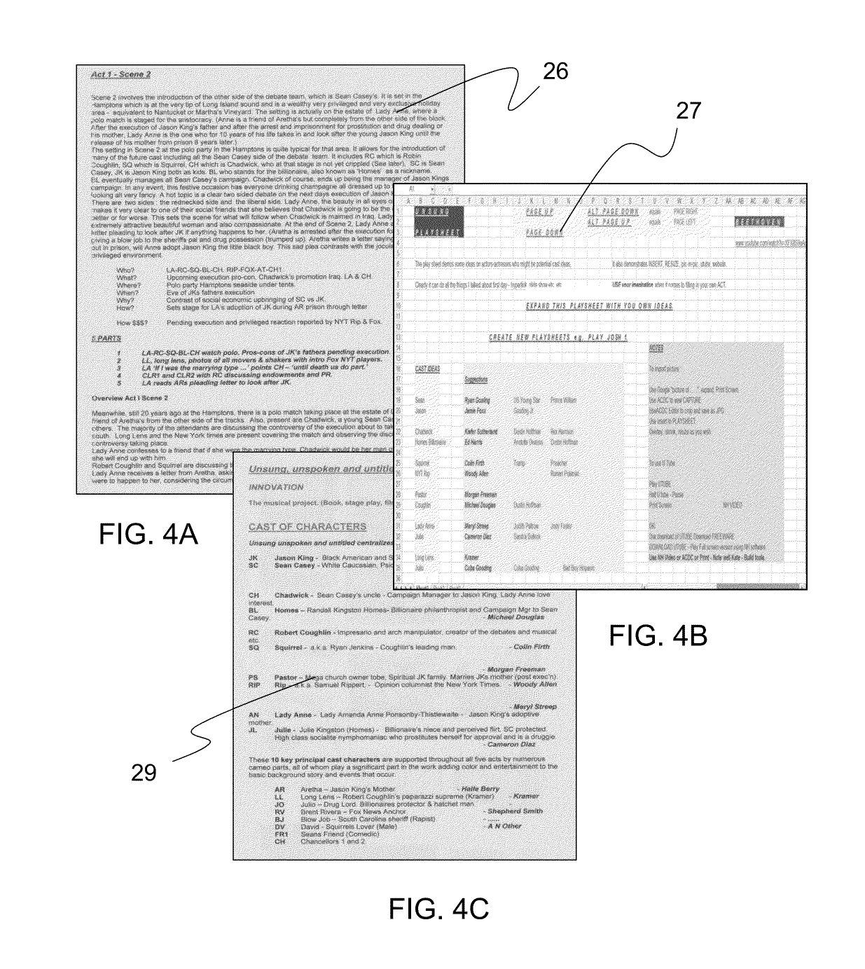

As shown in FIG. 4A, the Textual Plot Line 26 of the Basic Concept 12 lists out the Acts, Scenes and Part Scenes structured from the Architectural Blueprint 50 and the answers derived from the 6WCOOL Critical Content Components 211. A Play Sheet 27 is structured within the Architectural Blueprint 50 from the Plot Line 26 as shown in FIG. 4B to provide the layout of each Act, Scene, Part Scene and the structure of these elements of the PictoFilm. A Cast of Characters 29 as shown in FIG. 4C and Settings Options is also derived from the Textual Plot Line 26 with background and details on each character and Setting information to assist in the selection of locations and actors that may be cast in the roles in the PictoFilm.

### PictoFilm Architectural Blueprint Layout

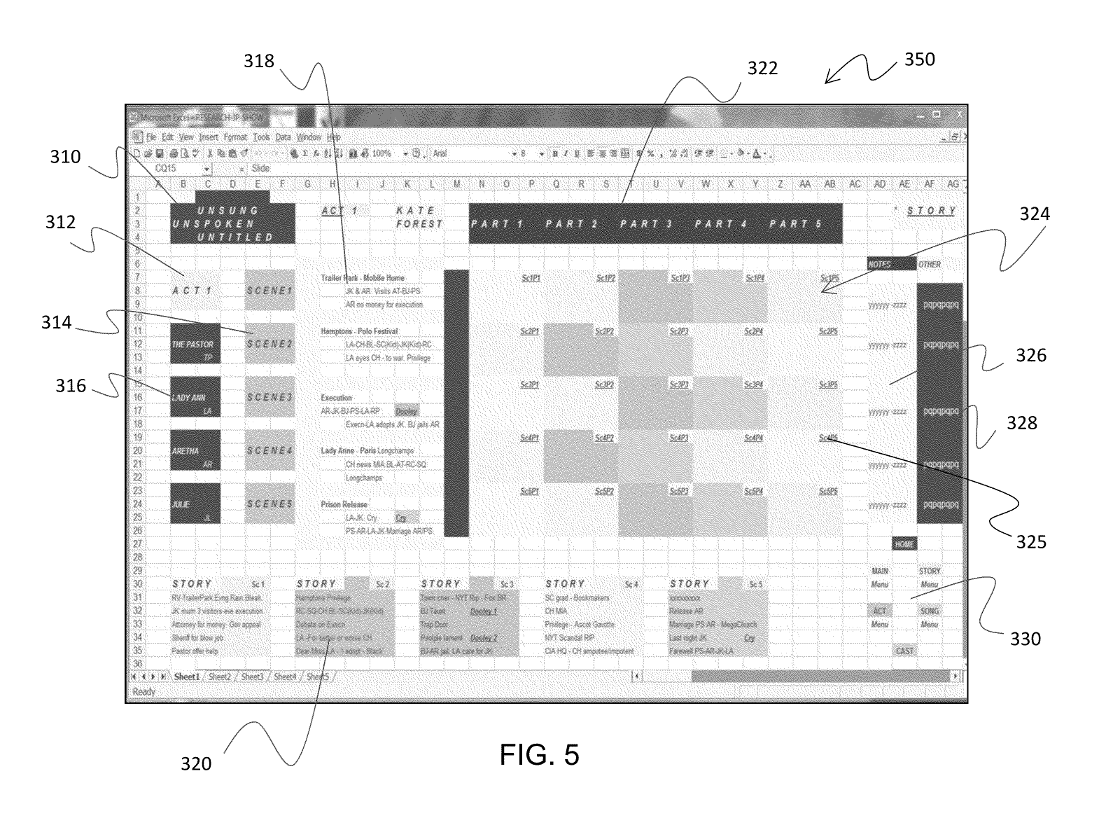

The Architectural Blueprint 50 consists or rows and columns of display pages, each known as an Audio Video Narrated, Musicked, Storyboards (AVNMSB) or the PictoFilm Blueprint StoryBoard 65. Each page also has a unique cell matrix structure critical for file and coordinate component file naming and referencing that provides for the remake and alternative content capability, critical to the invention. A Referenced Page Map 350 for each PictoFilm Blueprint StoryBoard 65, as shown in FIG. 5, represents initially a static blank Architectural Blueprint 54 depiction of an Act with each scene and it's Part Scenes with the components that make up each scene. The PictoFilm Blueprint StoryBoard 65 may have a title 310, the Act 312, the number of Scenes 314 within the Act 312 and the Characters 316 from the Textual Plot Lines 318 that will be used in the Act 312. PictoStorys 324 as described in U.S. Provisional Application No. 61/705,686 are created for each of the Part Scenes 322 from the selected images transformed into Enhanced Trans-Snips 58 and Composite Images 61. PictoStory Scene Summaries 320 are also created to provide a brief overview of each Scene 322. The PictoStorys 320 and PictoStory Summaries 320 are presented statically in the PictoFilm Blueprint StoryBoard 65.

The Reference Page Map 350 provides navigation to all of the components that make up the Acts 312, Scenes 314, Part Scenes 322, including all of the components of the PictoStorys 324, and PictoStory Summaries 320. The PictoFilm Blueprint StoryBoard 65 may also have Notes 326 and Other information 328 to assist in selecting characters and settings. The PictoFilm Application Software 10 associates Enhancements 68 with the components in the PictoFilm Blueprint StoryBoard 65 to encompass audio, video, slideshows, narration, and other contextual information as the principle basis for the envisioned Multi-Dimensional PictoFilm Presentation. Navigation Tools 330 may be provided to access control tools and other features in the PictoFilm Software Application.

Similarly, this PictoFilm Blueprint StoryBoard 65 acts as the source information for the ‘WebliZation’ of any scene which allows a rendering of a scene and its parts in the form of a web presentation available either on line or from a local hard drive. The PictoFilm ‘WebliZation’ Software feature allows access to all component parts of a scene or act including viewing the components statically, as a slideshow, or sequenced within a PictoFilm. Narration, music, sound, settings character profiles, visual effects and Enhancements 68 are all available in an Interim Version of the final expected simulated full motion video version of the work—any component of which can then be easily altered on the fly to test suitability (i.e. change actor or any setting previously inputted). This alterability is made possible by the Encrypted Coordinate File Naming System within the Architectural Blueprint 50 for referencing of files and page components.

### PictoFilm Variable Component Content Using the Choice Generator and Data Store Resource

This key feature of the Architectural Blueprint 50 is the cell structure which forms the basis for file naming or referencing of any or all component parts within a PictoFilm Blueprint StoryBoard 65 which may later be used for web or final presentation and/or alteration to create different versions of the same work. The Architectural Blueprint 50 further provides navigation to all of the selected images for the Settings and Characters that are chosen and are transformed to make the Trans-Snips 58 or Composite Images 61. The selected images are identified by the Choice Generator 22 that categorizes the images within the Data Store Resource 66 and stores these images with encrypted coordinate filing names that are associated with the required Critical Content concepts for the PictoFilm. For example, to support the SETTINGS Input Module, images for the Location, the Era-Time, the Event-Context, and the Action images are grouped separately based on these settings requirements. The image files are then stored with encrypted coordinate file names that represent locations within the Architectural Blueprint layout that are dedicated for these settings. In this way, a series of Image Selection Montage Pages displaying images for one of the Critical Concept Settings are developed by the Choice Generator 22 from the Data Store Resource 66. The images for an active Image Selector Montage Page are stored in the Data Store Resource 66 Active Output Folder with appropriate encrypted coordinate file names. Alternative Content components 64 are stored in Variable Content Folders with similarly appropriate encrypted coordinate file names, so that additional Image Selections are provided by simply moving the Variable Content to a Temporary Content Folder for rendering, or to the Active Output Folder to replace Content within the PictoFilm Blueprint StoryBoard to be presented in the Multi-Dimensional PictoFilm Presentation. Using the Production Controls 27 of the Architectural Blueprint 50 allows for the Alternative Component 64 to be rendered and realized within a Temporary Output Folder to be viewed within the film-like E-Enhanced Multi-Dimensional PictoFilm Presentation 72. If the Alternative Component 64 selection is transferred from the Variable Output Folder to the final in use or Active Output Folder it has the effect of completely transforming the PictoFilm Presentation 72 with the replacement of any Component or enhancement providing effortless, infinite variations of the same Basic Concept 12.

### PictoFilm Settings—Geographic Location; Era-Time-Season-Weather; Event Context; Event Action & Outcome

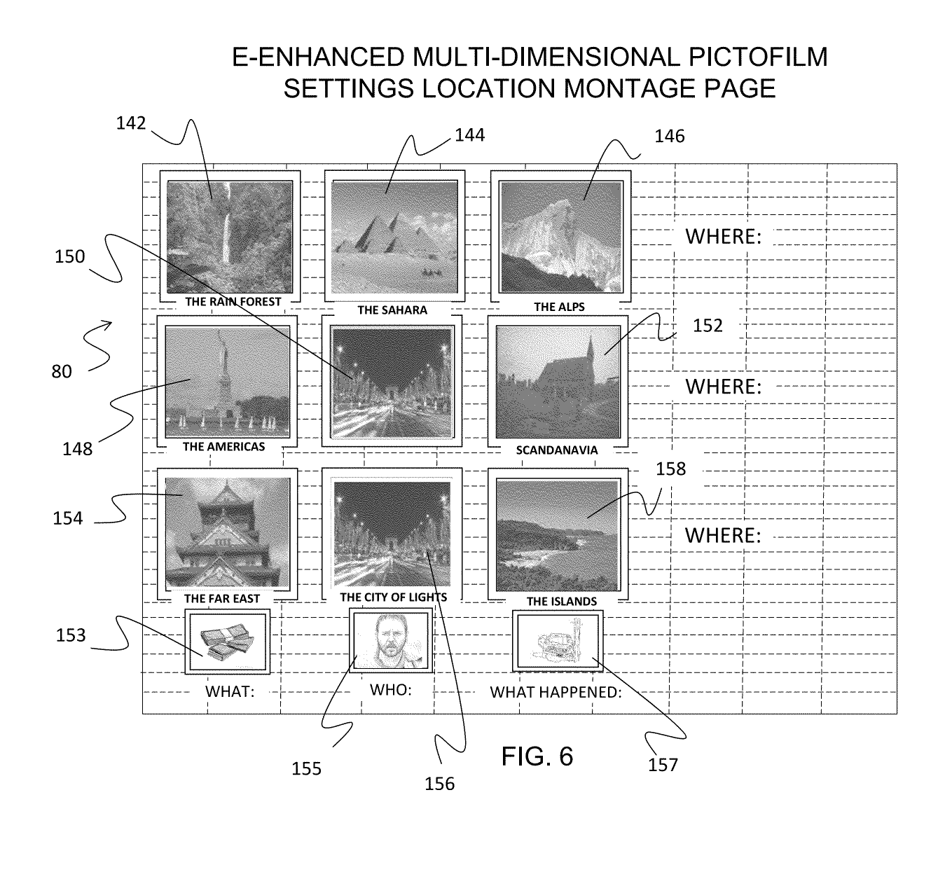

The Settings—Location Montage Page 140 is developed with a set of eight labeled pictures in a 3×3 format surrounding a center picture. Within the Montage Page 140 in a first example as shown in FIG. 6, the Location Montage Page 140 may show places around the world for Settings for the PictoFilm with a selected image being shown in the center picture 150. These geographic locations are labeled images of the Rain Forest 142, the Sahara 144, the Alps 146, the Americas 148, Scandinavia 152, the Far East 154, the City of Lights 156 and the Islands 158. Image Selector Montage Pages 80 are setup for each Settings requirement and for each Scene by Scene and each Part Scene by Part Scene to assemble the required critical content for these scenes. Access to other required content for the Settings may be available on the Montage Page 80 such as access to other Montage Pages for critical content for the What? 153, Who? 155 and What Happened? 157. The selection inputs are transformed using the PictoLayer Generator 60 into Embedded Coded PNG Format Trans-Snips 58. The Trans-Snips 58 are layered using the PictoComposite Generator 62 to create a Composite Image 61 that pictorially represents each part of a PictoStory that is used within a scene. For example, in a scene, to represent a location setting, the image selection of Paris may become a Composite Image 61 that may include Trans-Snips 58 of the Eiffel Tower, the Arch de Triumph, the French flag and croissants to encapsulate pictorially, and emotively project the country of France. One of the Image Selection Montage Pages 80 may include an event that is secretly transformed to show why the PictoFilm is in Paris. Other series of Image Selection Montage Pages 80 are developed for each SETTING critical content requirement with additional content supplemented by the Choice Generator 22 and Data Store Resource 66 that is connected to the Internet to continual supplement the image content and provide additional images to choose from.

### Selected Settings PictoFilm Blueprint StoryBoard

A selected image that pictorially represents some required content for the Settings in a Part Scene or Scene is saved with an Encrypted Coordinate File Name that is associated with a designated coordinate for the content as defined in the layout of the Architectural Blueprint 50. Settings selections for the Geographic Location; Era-time-season-weather; Event Context; Event Action; and Outcome are all located in designated locations defined by the Blueprint Generator 52. The image selections are then transformed into Trans-Snips 58 and Composite Images 61 to be used to create a PictoStory 324 to be used in a Part Scene 322.

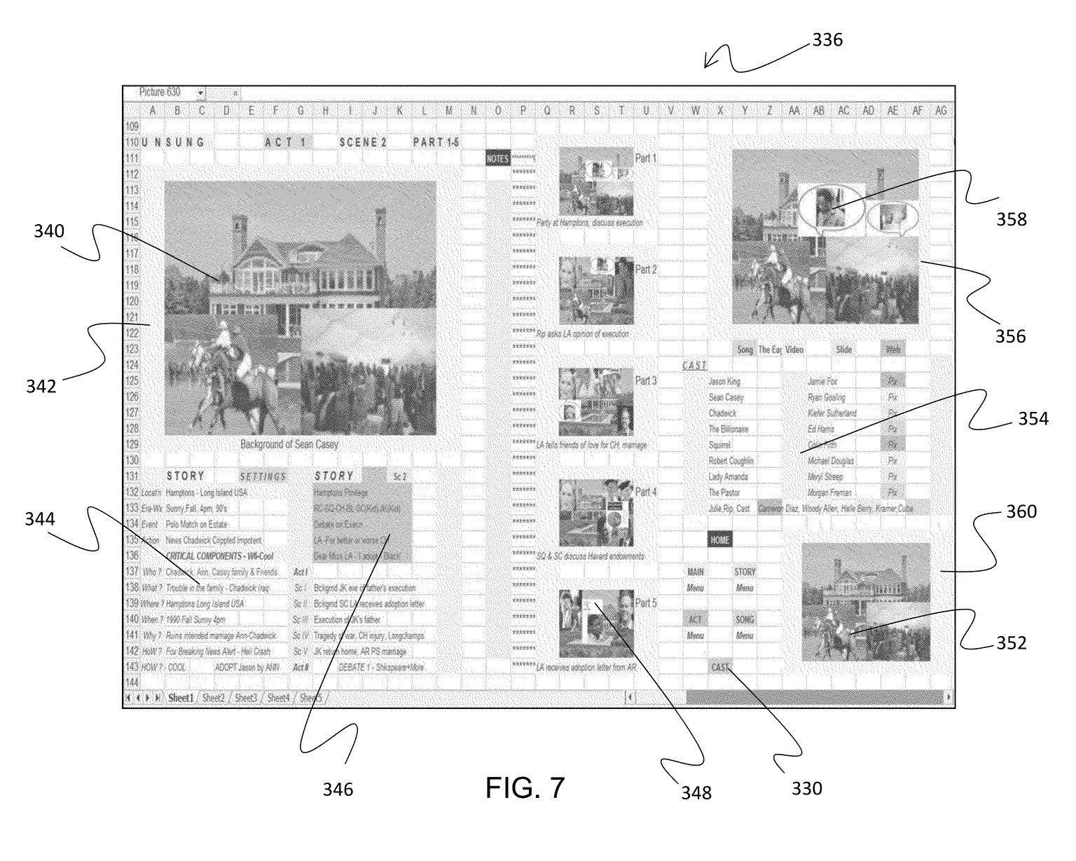

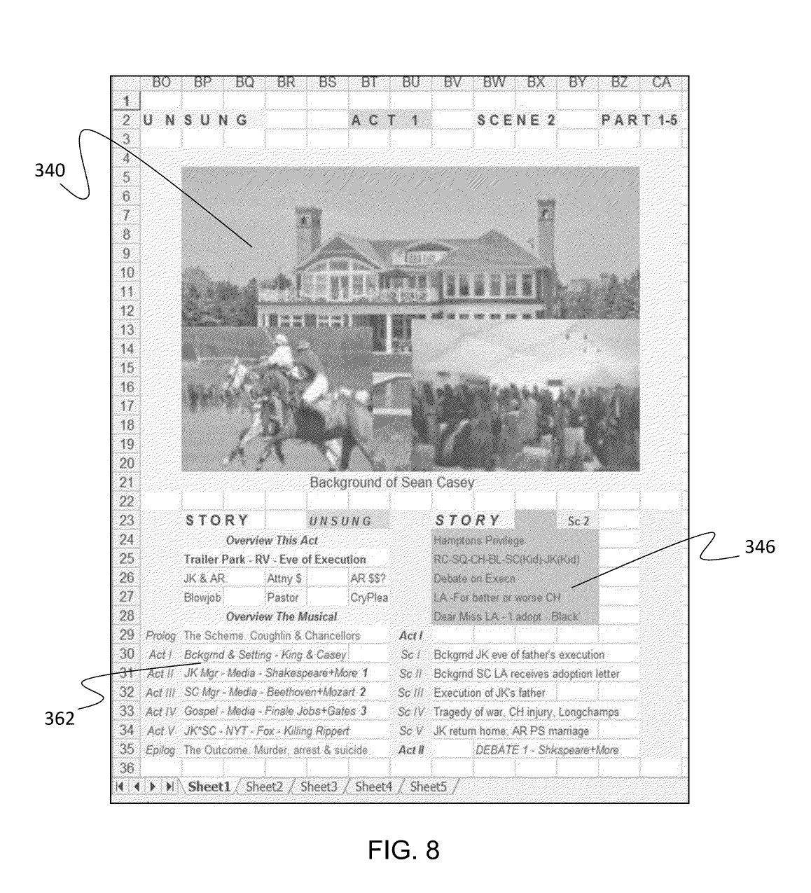

As shown in FIG. 7, the Settings Composite Image 340 may be displayed in a Static Viewer 342 within a PictoStory Blueprint StoryBoard 336 within the PictoFilm Architectural Blueprint 50. A description of the Settings 344 and the storyline 346 as defined in the Textual Plot Line 26 may be provided in the PictoStory Blueprint StoryBoard 336. The PictoStory may be made up of five separate Composite Images 61 that are accessible in the Part Scene Viewer 348 in the PictoStory Blueprint StoryBoard 336. The PictoStory Blueprint StoryBoard 336 may also provide a Slide Show Viewer 368 to view a Composite Image 352 and properly sequence the PictoStory 324 within a Part Scene 322 and a Video Viewer 356 to render the Part Scene 322 into the Multi-Dimensional PictoFilm Presentation 72. Alternative Components 358 may be rendered and reviewed using the Production Control Tools 27 of the Architectural Blueprint 50. Additional Information 354 on a selected Cast and Enhancements is also accessible. A shown in FIG. 8, background music, narration, and sound information 362 through Enhancements 68 associated with Act, Scene or Part Scene may be accessible in the PictoStory Blueprint StoryBoard 336.

### PictoFilm Profiles—Cast Identification and Character Selection Module

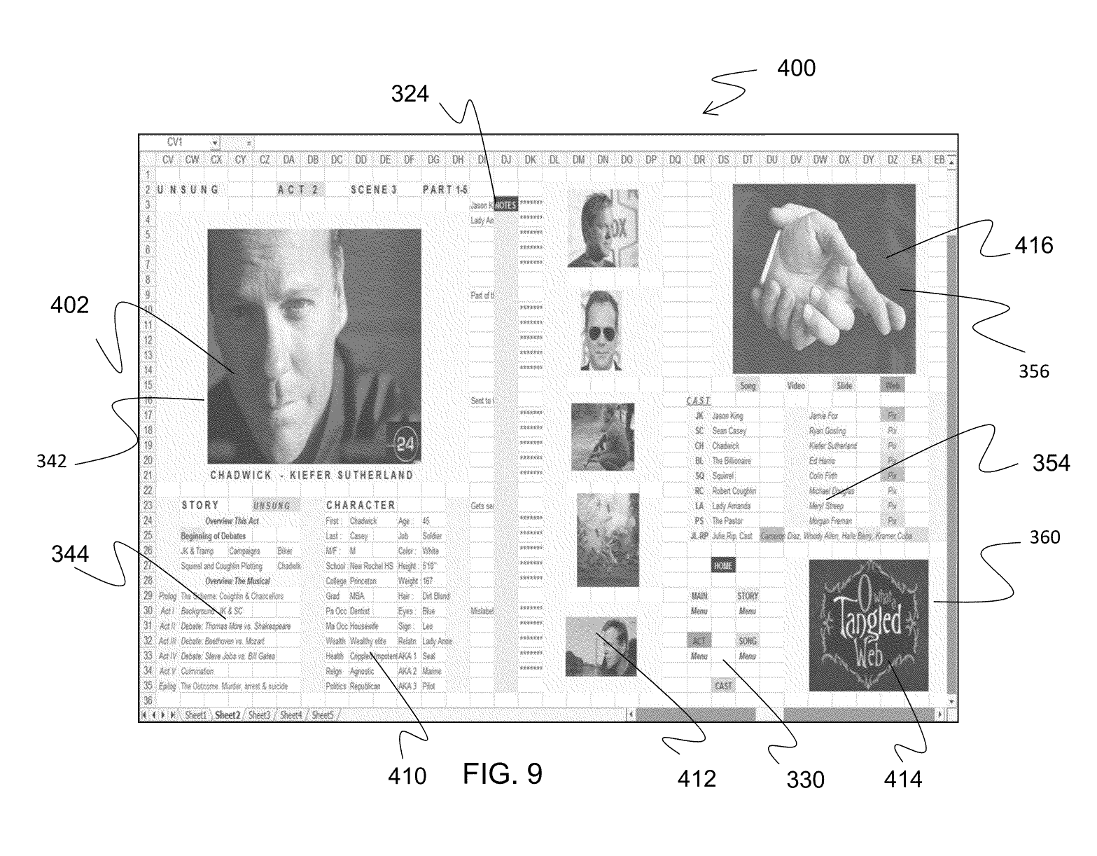

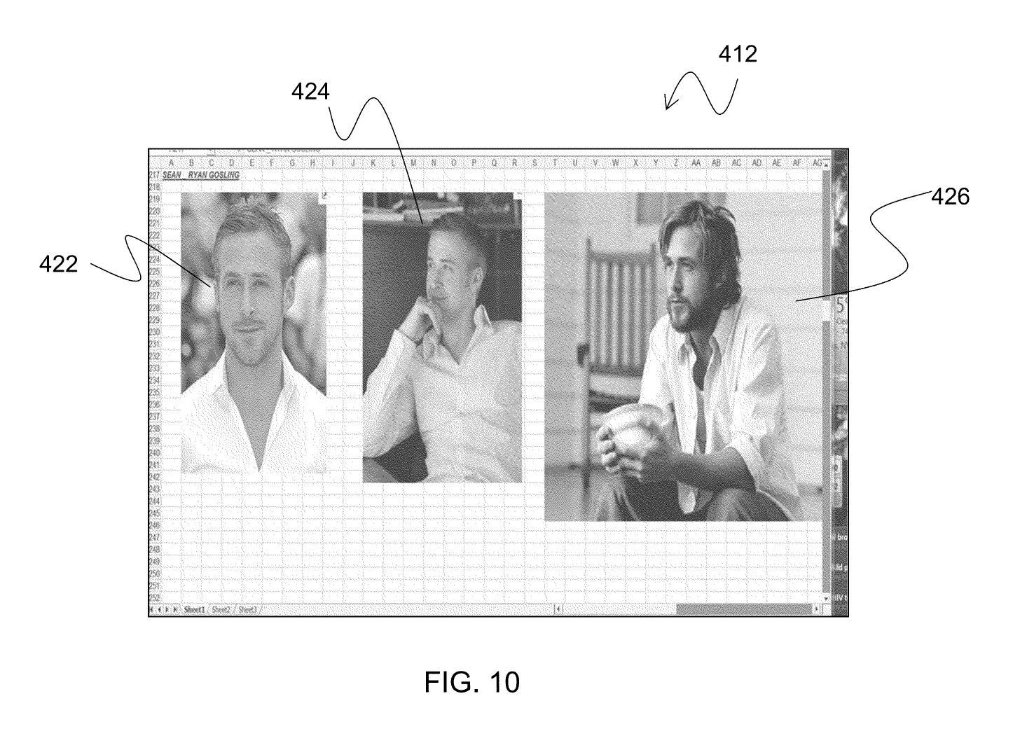

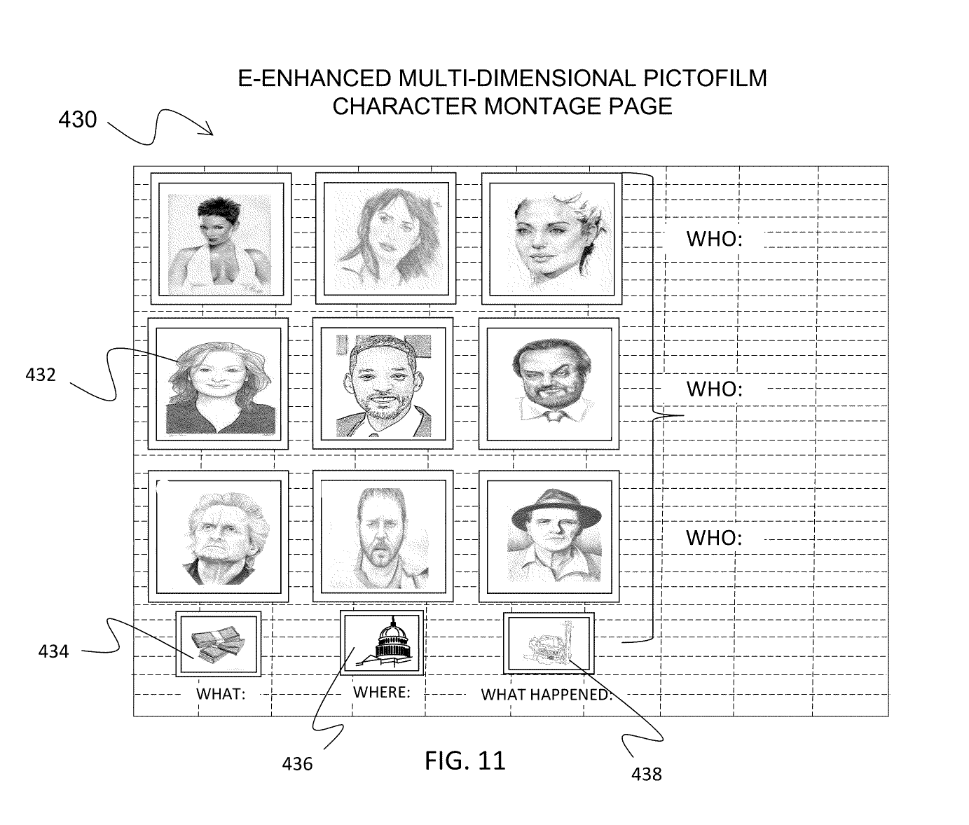

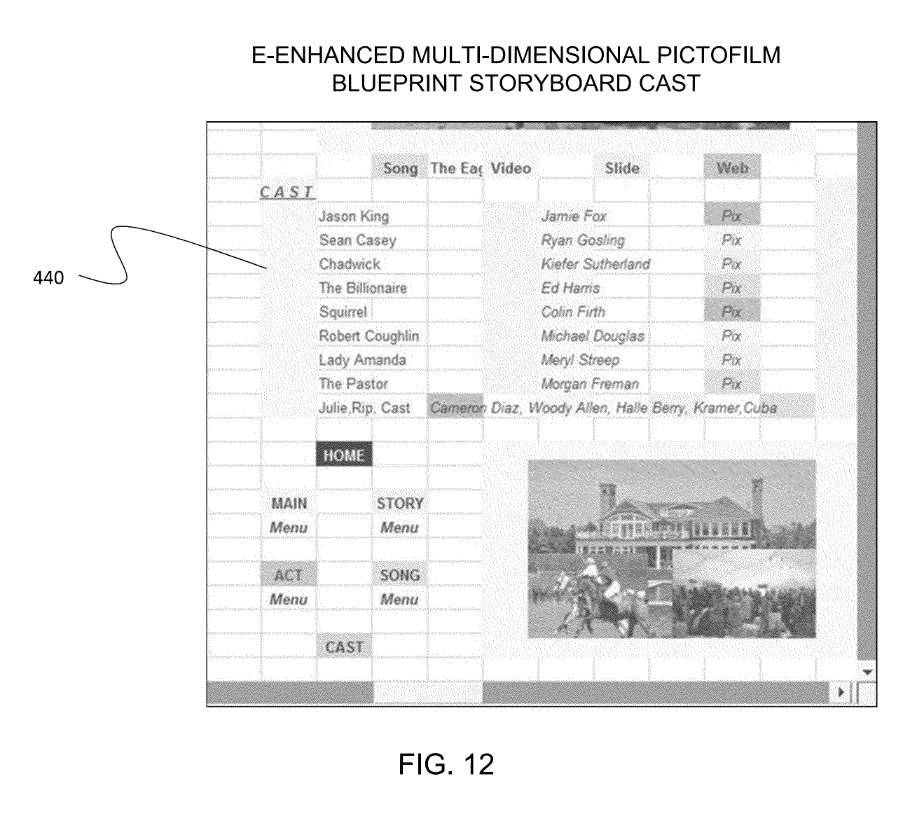

For each character in the Data Store Resource 68, a Character Profile 400 as shown in FIG. 9 is created which has two main elements: a detailed biography 410 of the individual including personal information and looks-characteristics; and secondly an image library 412 of a living-dead actor to play the part of a cast member. The Character Profile 400 may be reviewed using the static viewer 342 displaying a first image 402 of the Actor. The slide show image 414 may provide additional information and the video viewer 356 may show a film 416 of the actor performing. The image library 412, as shown in FIG. 10, may provide a number of poses of the actor for a user to select from for a particular scene in the PictoFilm. To initially determine an appropriate cast member for a particular role in the PictoFilm, a Character Montage Page may be used to provide access to a number of Character Profiles 400 as shown in FIG. 11. By selecting any image 432 the Character Profile 400 for that actor opens for review. Other options to access other Montage Pages such as for What is the context of the scene? 434, Where for a location setting? 436, and What Happens? 438. The Character Images 432 are created using the Choice Generator 22 and thousands of options may be available for characters in the Data Store Resource 68 with updates to any Character Profile 400 to remain current through an Internet connection. As cast members are selected, the Character Profiles 400 are located within the appropriate Scenes and Part Scenes in the PictoFilm Blueprint StoryBoard 65. As shown in FIG. 12, by locating a Character Profile 400 within the PictoFilm Blueprint StoryBoard 65 information in the list of Cast Members 440 is updated. The user creator may vary or add to any of these personality traits or requirements to change a selection of a cast member to better suit the production values as required.

### Process Steps of Preferred Embodiment

STEP 1. CREATE—Uses a Base story-concept-Concept structure and Textual Plot Line developed by the PictoFilm Generator to input defined Critical Content Components (6WCOOL). The Audio Video PictoFilm Creator Application Software takes an original story—concept-idea and uses ‘Act-by-Act, Scene-by-Scene’ user input to specify ‘Critical-Key Content Component Inputs’. This input creates and generates an integrated sequence structure called the Architectural Blueprint comprising Audio Video Narrated Musicked PictoFilm StoryBoards depicting a sequenced static preview full version of the user-creator's initial basic story concept. The critical content components are known as ‘6WCOOL’ and are fully defined software versions of the questions—Who?, What?, When?, Where?, Why?, HoW?, and How COOL?—meaning to deliver dramatic effect.

STEP 2. SETTINGS.—The operator then inputs context defined ‘Input Settings’ for the proposed structure and scene by scene sequence based on the generated Textual Plot Line 26, defined in CREATE [Step1] above. These settings describe and further define the story line to necessarily include settings regarding: 1. Geographic Location, 2. Era-Season-Weather-Time, 3. Event Context, and 4. Event Action for each scene-by-scene PictoFilm StoryBoard.

STEP 3. PROFILES. The Operator uses PictoFilm Character PROFILES' to further define the cast and characters in the storyline. PROFILES allow and suggest input headings regarding a complete socio-economic-academic-cultural-ethnical-ethical-religious profile of each cast-character member in the project-story including statistics on birth, sex, location, height weight color, eyes, hair and multiple other features that define one individual from another.

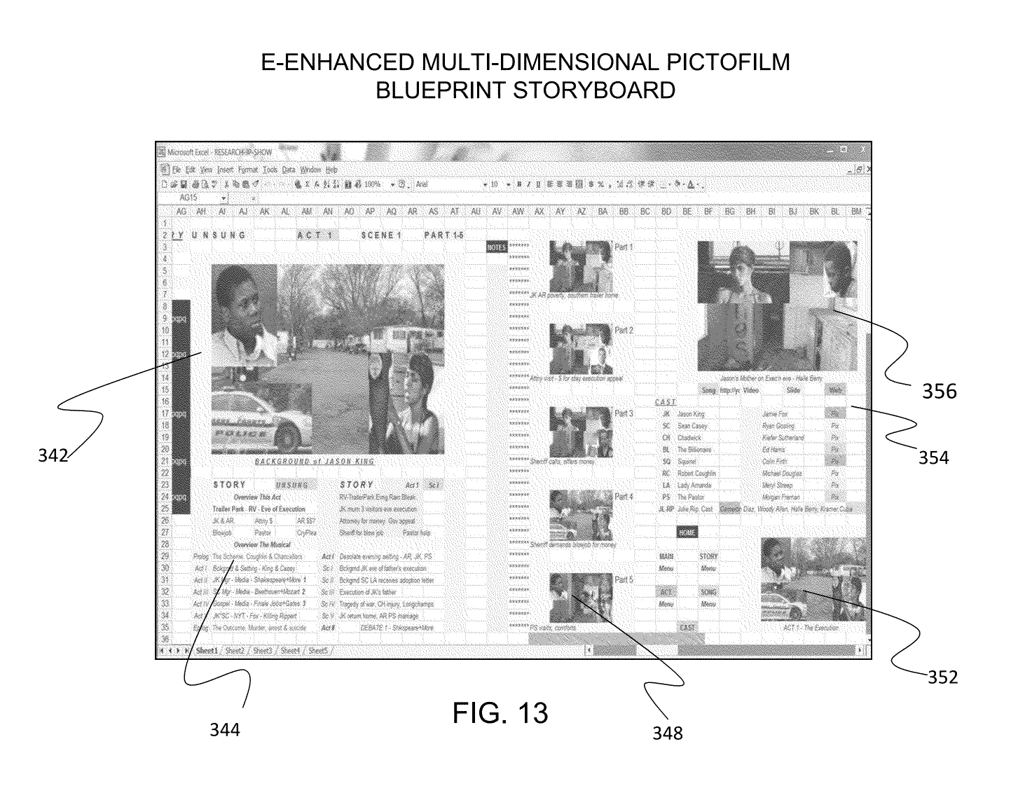

STEP 4. THE ARCHITECTURAL BLUEPRINT. The Architectural Blueprint is a process the user follows to take the basic core inputs generated in Steps 1-3 above to generate a total, comprehensive visualization of the structure, sequence, storyline-idea for the characters, settings and event actions and outcome contemplated in each scene. This visualization is in the form of structured pages on a large Architectural Blueprint, where each scene in each act is represented by a one page display consolidating and defining the user inputs from the steps above. These scene by scene ‘display pages’ are known as Audio Video Narrated Musicked StoryBoards (AVNMSB) or PictoFilm Blueprint StoryBoards. They include everything conceivable that may relate to a scene. The important component of the PictoFilm Blueprint StoryBoard is the structural representation of a scene using the Sequence of Elements 34 and Textual Plot Lines to generate a Play Sheet 27 that defines the sequence of content within a Scene or Part Scene. The pictorial input from settings and character selections are then transformed into Trans-Snips 58 and combined, compiled and overlaid to generate the series of composite images that form a PictoStory as a part of the five parts within a Scene. The Trans-Snips 58 are enhanced with embedded code to create the effect in a slideshow of seeing cut by cut action in a full motion video. A shown in FIG. 13, this layering effect of Trans-Snips 58 shown statically in the Static Viewer 342 can create an emotive representation with multiple characters in a complex storyline. The sequencing of each Composite Image 61 may be ordered and controlled with the ability using the prioritization attribute of an Enhancement 68 associated with a Trans-Snip 58 to perfectly time Theme Music, Background Music, Narration and other audio and visual effects by simply selecting to layer or prioritize one Trans-Snip 58 or Enhancements 68 over another using the Slide Show Viewer 352. As part of this process, the system allows these PictoFilm Blueprint StoryBoards to be activated which by means of adding narration, theme music, songs and other effects results in an INTERIM display simulating that scene from the initial user-operator input. Static input now has audio, narration, video, songs, slideshows and relevant accompanying full motion video.

STEP 5. REALIZE, RENDER, REMAKE—The Variable Component features within the PictoFilm Application Software create a base version of the PictoFilm and allows for the creation of Alternate, Additional Versions by modifying altering, adapting or changing the original versions components to generate an alternate version of the Multi-Dimensional PictoFilm Presentation providing for the saving of backup versions and the remaking of multiple version with varied actions, events and outcomes. The REALIZATION process is achieved by utilizing optional enhancements to the WebliZation process to create an even more realistic rendition of the original work using Enhancement 68 to closely resemble a simulated full motion picture version of the original Basic Concept 12.

STEP 6. SLIDE SEQUENCING—Slide Generation & Slide Sequencing Compilation Generator 261 is applied to any versions of the completed or modified full sequence of the PictoFilm Blueprint StoryBoard 65 and the Settings/Critical Components as described to necessarily include Scene-by-Scene rendition methods and software that create the impression of full motion video, by utilizing Enhanced Trans-Snips and the PictoOverlays with narration, songs, theme music & other elements and display techniques that are unique to the PictoFilm Software Application system.

STEP 7. SONG-MUSIC A Song & Theme Music Generator 262 provide methods, techniques & software to include a production element using the prioritization of Trans-Snips 58 and Enhancements 68 to properly time and sequence, Theme Music, Background Music, Narration, Sound and Visual Effect applied to the PictoFilm StoryBoard and the Settings/Critical Components to necessarily include Scene-by-Scene rendition to add the Enhancements 68 to the full motion video.

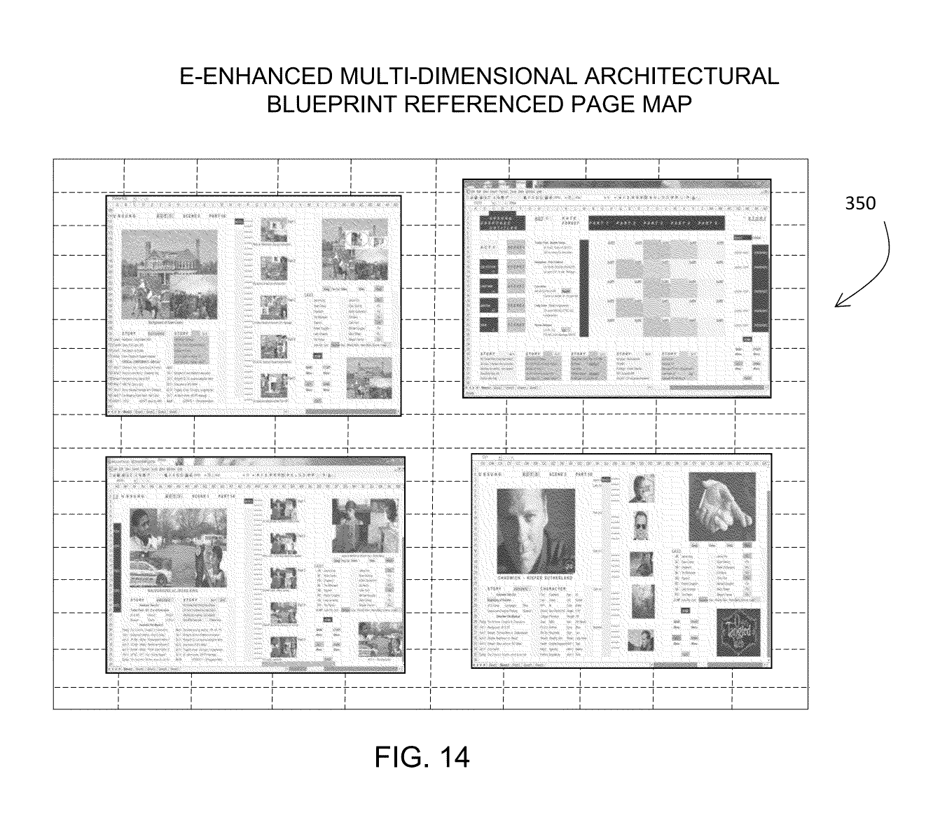

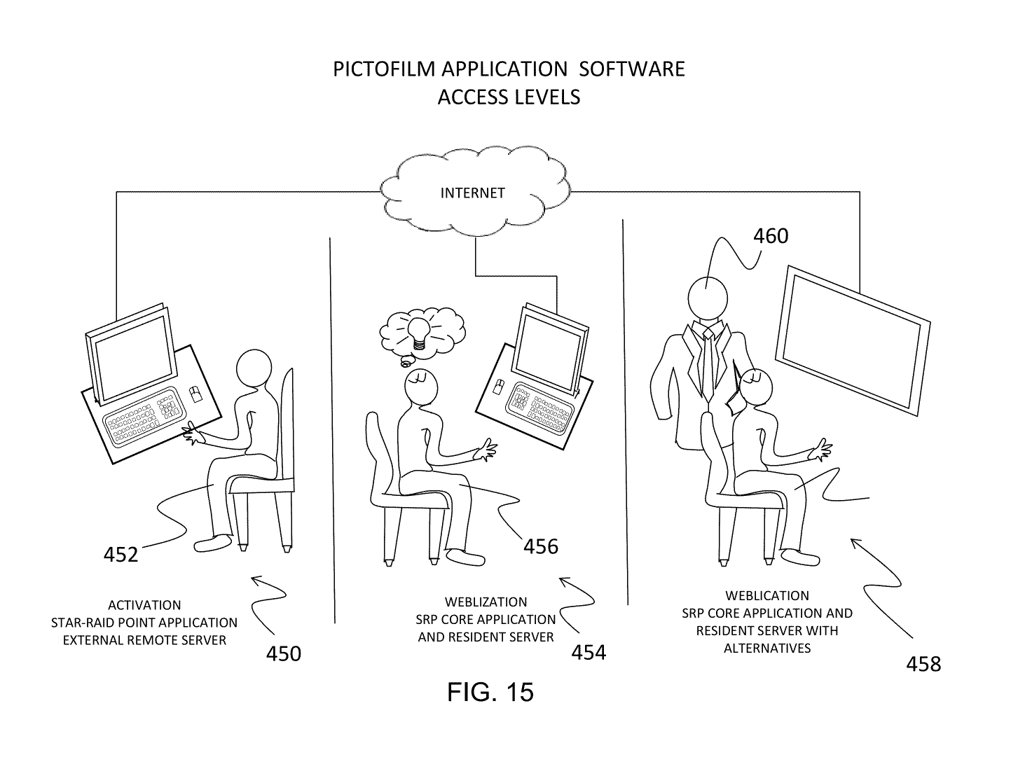

STEP 8. OUTPUT GENERATOR—The Output Generator of the PictoFilm Application Software generates an expanded full length “Pilot Preview” of the Basic Concept 12, by creating, combining and sequencing scene by scene components of the storyline in the form of ‘Audio Video Narrated Musicked PictoFilm StoryBoards’, which as a whole, render a simulated ‘Preview PictoFilm’ of the original Basic Concept 12 and this version is supplemented by the capability to print and display and component or portion of an individual PictoFilm Blueprint StoryBoard which includes an edit/modify interface that allows simple modification to create additional and alternate full video versions of the work. Every PictoFilm Blueprint StoryBoard is accessible as shown in FIG. 14 using the Referenced Page Map 350 to easily navigate and access any component.

### PictoFilm Application Access Levels

Any Multi-Dimensional PictoFilm Presentation has viewing levels that provide for the presentation to be accessible through a web hyperlink, internet or networked connection. The viewing levels are administrative controls that control the access to the Multi-Dimensional PictoFilm Presentation. A first level of access, Activation, is only accessible using the STAR-RAID-POINT PictoFilm Development Software Application 10 that provides complete access to view all content and variable content and components within the Architectural Blueprint 50 to control, arrange, change, modify, replace and edit the content of all Components, Sub-Components and Enhancements. Control System Tools at this access level provide the ability to amplify all or any portion of the content such as to activate a single enhancement associated with a Composite Image 61 or to activate a portion of the Multi-Dimensional PictoFilm Presentation using any number of enhanced Composite Images 61 or other components. At the Activation level 450, Rendering and Realization is performed by a Developer 452 who using the STAR-RAID-POINT PictoFilm Development Software Application 10 may create and pictorially present, edit, modify, enhance, navigate, and transform any Component within the PictoFilm Blueprint StoryBoards 65. Upon draft or final completion, the Developer 452 renders any PictoFilm Blueprint StoryBoard 65, Composite Image 61, or Enhancement 68 to provide restricted access for viewing all or any part of an E-Enhanced Multi-Dimensional PictoFilm Presentation. The activation is done within the Architectural Blueprint 50 and may be performed using Hyperlinks, macros, Dynamic HTML, Java Script, and other integrated application.

A second access level is WebliZation 454 which provides internal, client-based access to view all or portions of an E-Enhanced Multi-Dimensional PictoFilm Presentation. The WebliZation Access Level 454 provides a web hyperlink to access the PictoFilm Presentation to allow a user to interact with a Multi-Dimensional PictoFilm Presentation such as allowing a user to select Alternative Components 64, Sub-Components and Enhancements 68 and view these changes within a temporary file structure to determine the final version of the PictoFilm Presentation data content.

For example, at the WebliZation Access Level 174, in a further embodiment, an Enhanced Multi-Dimensional PictoFilm Presentation may be provided in an Enhanced Dynamic HTML, proprietary, internal client-based format that allows a Producer 456 to view, partially edit, and select Alternative Components 64 within the required Critical Content or Enhancements 68 to change the dynamic presentation of a component. Final rendering for permanent replacement of Alternative Components 64 and other interchangeable components may not be provided at the WebliZation level, however viewing in an Interim Output of the PictoFilm presentation incorporating the Alternative Components 64 provides for a determination of alternatives that may be communicated to the Developer 452 for final rendering to implement the suggested changes by the Producer 456.

The third level of access is the WebliCation Level 458 that provides web based access through a secure website format to view, note, suggest view potential modifications, test, etc. an E-Enhanced Multi-Dimensional PictoFilm Presentation. In one embodiment, the viewer 460 at the WebliCation Level 458 may be allowed to suggest and select Alternative Components 64 associated with the Basic Concept 12 and request a change to a Multi-Dimensional PictoFilm Presentation providing interaction to the viewer to review dictate the characters, settings, events and outcomes of the Multi-Dimensional PictoFilm Presentation. Permanent modifications to the Multi-Dimensional PictoFilm Presentation at this level are prevented, but the changes selected by a viewer are seamlessly integrated into the Multi-Dimensional PictoFilm Presentation using the Alternative Components 64 associated with the required Critical Content, content that is stored as Variable Content using the Encrypted Coordinate File Naming Structure defined in the Architectural Blueprint.

Access through WebliCation 458 allows a third party 460, an investor for example to view the final E-Enhanced Multi-Dimensional PictoFilm Presentation through the secure website to for example help the Producer 456 acquire financial backing for the Basic Idea 12 in order to record, film, or perform the Basic Idea 12 as a song, a musical, a video, a play, a 1 video game, a full length movie, an educational Summary or display the Basic Idea 32 in other presentation formats. The Developer 452 publishes the project through the secure website in a .COM format which in turn renders full functionality to all Enhancements and features of the PictoFilm Presentation for viewing or selecting and suggesting Alternative Components 64. With minimal initial investment using the PictoFilm Development Software 10 a dynamic E-Enhanced Multi-Dimensional PictoFilm Presentation is created to intrigue, entertain, educate, and have users be informed about the Basic Concept 12.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

What is claimed is:

1. An audio video film creator software system for the creation of an enhanced multi-dimensional pictofilm presentation, comprising:
application software installed on a computer system;
the application software further comprising;
a blueprint generator;
a pictofilm generator;
a pictolayer generator;
a pictocomposite generator;
an enhancements generator; and
wherein the blueprint generator structures an architectural blueprint with a plurality of required critical content based on a basic concept;
the pictofilm generator structures a plurality of textual plot lines for a plurality of acts, scenes and part scenes and applies the required critical content to each of the plurality of acts, scenes and part scenes;
the pictolayer generator stylizes a plurality of trans-snips from a plurality of images pictorially representing the required critical content for each of the plurality of acts, scenes and part scenes;
the pictocomposite generator layers the plurality of trans-snips to form at least one composite image;
the pictofilm generator creates at least one pictostory from at least one composite image representing the required critical content for each of the plurality of acts, scenes and part scenes;
the enhancements generator associates and prioritizes at least one enhancement with one of at least one of a trans-snip, a composite image, a pictostory, an act, a scene and a part scene within the architectural blueprint; and
the production controls sequence at least one pictostory to create an enhanced multi-dimensional pictofilm presentation.

2. The audio video film creator software system for the creation of an enhanced multi-dimensional pictofilm presentation of claim 1, wherein the pictofilm generator structures the required critical content into a plurality of elements for each act, scene and part scene and applies a 6WCOOL query in a responsive format to the plurality of elements to create the expanded textual plot line.

3. The audio video film creator software system for the creation of an enhanced multi-dimensional pictofilm presentation of claim 1, wherein the required critical components include one of at least a settings location, a time, an event, an outcome and a character.

4. The audio video film creator software system for the creation of an enhanced multi-dimensional pictofilm presentation of claim 3 further comprising a choice generator grouping variable content for selection of required critical content.

5. The audio video film creator software system for the creation of an enhanced multi-dimensional pictofilm presentation of claim 4 wherein the grouped variable content is stored within a data store resource using an encrypted coordinate file naming structure.

6. The audio video film creator software system for the creation of an enhanced multi-dimensional pictofilm presentation of claim 3 further comprising character profiles.

7. The audio video film creator software system for the creation of an enhanced multi-dimensional pictofilm presentation of claim 1, wherein at least one trans-snip from the plurality of trans-snips is formed by shaping, cropping, sizing, removing a white background of an image representing a required critical component and locating the image on a blank transparent sheet.

8. The audio video film creator software system for the creation of an enhanced multi-dimensional pictofilm presentation of claim 1, wherein the architectural blueprint further comprises a reference page map.

9. The audio video film creator software system for the creation of an enhanced multi-dimensional pictofilm presentation of claim 1, wherein an enhancement is at least one of audio files, recorded narration, animation, video files, video effects, sound effects, slide shows, and image components.

10. A method of creating a multi-dimensional pictofilm presentation, comprising the steps of:
installing application software on a computer system;
structuring an architectural blueprint within the application software with a plurality of required critical content;
developing a textual plot line using a pictofilm generator within the application software based on a basic concept and the required critical content;
structuring a plurality of acts, scenes and part scenes based on the textual plot line;
applying the required critical content to each of the plurality of acts, scenes and part scenes;
forming a plurality of trans-snips from a plurality of images pictorially representing the required critical content for each of the plurality of acts, scenes and part scenes;
layering a plurality of trans-snips to form at least one composite image;
creating at least one pictostory from the at least one composite image;
associating and prioritizing at least one enhancement with one of at least one of a trans-snip, a composite image, a pictostory, an act, a scene and a part scene within the architectural blueprint; and
sequencing at least one pictostory to create an enhanced multi-dimensional pictofilm presentation.

11. The method of creating a multi-dimensional pictofilm presentation, of claim 10 further comprising the step of structuring the required critical content into a plurality of elements for each act, scene and part scene and applying a 6WCOOL query in a responsive format to the plurality of elements to create the expanded textual plot line.

12. The method of creating a multi-dimensional pictofilm presentation, of claim 10 further comprising the step of including within the required critical components at least one of a settings location, a time, an event, an outcome and a character.

13. The method of creating a multi-dimensional pictofilm presentation, of claim 10 further comprising the step of grouping variable content using a choice generator for selection as required critical content.

14. The method of creating a multi-dimensional pictofilm presentation, of claim 13 further comprising the step of storing the grouped variable content within a data store resource using an encrypted coordinate file naming structure.

15. The method of creating a multi-dimensional pictofilm presentation, of claim 10 further comprising the step of creating character profiles.

16. The method of creating a multi-dimensional pictofilm presentation, of claim 10 further comprising the step of forming at least one trans-snip from the plurality of trans-snips by shaping, cropping, sizing, removing the white background of an image representing a required critical component and locating the trans-snip on a blank transparent sheet.

17. The method of creating a multi-dimensional pictofilm presentation, of claim 10 further comprising the step of navigating the architectural blueprint using a reference page map.

18. The method of creating a multi-dimensional pictofilm presentation, of claim 10 further comprising the step of enhancing at least one of a trans-snip, a composite image, a pictostory, an act, a scene and a part scene within the architectural blueprint with at least one of audio files, recorded narration, animation, video files, video effects, sound effects, slide shows, and image components.
